(19) United States
(12) Patent Application Publication
(10) Pub. No.: US 2024/0034094 A1
(43) Pub. Date: Feb. 1, 2024

(54) RUBBER COMPOSITION FOR TIRE TREAD AND TIRE USING THE SAME

(71) Applicant: Toyo Tire Corporation, Itami-shi (JP)

(72) Inventors: Yuma Nishikawa, Itami-shi (JP); Norio Minouchi, Itami-shi (JP)

(73) Assignee: Toyo Tire Corporation, Itami-shi (JP)

(21) Appl. No.: 18/219,305

(22) Filed: Jul. 7, 2023

(30) Foreign Application Priority Data
Jul. 29, 2022 (JP) 2022-122190

(51) Int. Cl. B60C 1/00; C08L 9/06; C08F 2/04; C08K 3/36; C08K 5/01; C08K 5/521

(52) U.S. Cl. CPC B60C 1/0016; C08L 9/06; C08F 2/04; C08K 3/36; C08K 5/01; C08K 5/521; C08L 2205/025; C08L 2205/03

(57) ABSTRACT

Provided are a rubber composition for a tire tread, which is capable of improving rolling resistance and abrasion resistance, and a tire using the same.

The rubber composition for a tread includes: 100 parts by mass of a rubber component containing 30 parts by mass or more of a solution-polymerized styrene butadiene rubber and less than 50 parts by mass of a diene-based rubber other than styrene butadiene rubbers; 60 parts by mass or more of silica; and a trialkyl phosphate in an amount of 1.5 to 20 mass % of the silica content.

### BACKGROUND OF THE INVENTION

### 1. Field of the Invention

The present invention relates to a rubber composition for a tire tread and also to a tire using the same.

### 2. Description of Related Art

In recent years, with the growing interest in environmental issues, for rubber compositions used in tires, a reduction in rolling resistance has been demanded from the viewpoint of fuel efficiency. Meanwhile, in order to obtain the required wet grip braking performance, silica may be highly loaded. However, high loading of silica possibly leads to the aggregation of silica, resulting in the deterioration of abrasion resistance or the deterioration of rolling resistance.

### SUMMARY OF THE INVENTION

In view of the above points, an object of an aspect of the invention is to provide a rubber composition for a tire tread capable of improving rolling resistance and abrasion resistance, and also a tire using the same.

Incidentally, JP2014-518912A describes, as a tire excellent in wet grip performance and abrasion resistance, a tire containing a rubber composition including an emulsion styrene/butadiene copolymer, an inorganic reinforcing filler, and a plasticizer. However, unlike the invention, a solution-polymerized styrene butadiene rubber is not used.

In addition, JP6244033B describes the combined use of a glycerin fatty acid ester and silica. However, unlike the invention, a phosphate ester is not used.

The invention encompasses the following embodiments.

[1] A rubber composition for a tread, including: 100 parts by mass of a rubber component containing 30 parts by mass or more of a solution-polymerized styrene butadiene rubber and less than 50 parts by mass of a diene-based rubber other than styrene butadiene rubbers; 60 parts by mass or more of silica; and a trialkyl phosphate in an amount of 1.5 to 20 mass % of the silica content.

[2] The rubber composition for a tread according to [1] above, in which the trialkyl phosphate has 3 to 30 carbon atoms.

[3] The rubber composition for a tread according to [1] or [2] above, in which the solution-polymerized styrene butadiene rubber includes a modified solution-polymerized styrene butadiene rubber.

[4] The rubber composition for a tread according to any one of [1] to [3] above, further including hydrocarbon-based resin.

[5] A tire including the rubber composition according to any one of [1] to [4] above used in a tread thereof.

According to a rubber composition for a tire tread of an aspect of the invention, rolling resistance and abrasion resistance can be improved.

### DESCRIPTION OF EMBODIMENTS

Hereinafter, matters relevant to the practice of the invention will be described in detail.

A rubber composition for a tire tread according to this embodiment includes: 100 parts by mass of a rubber component containing 30 parts by mass or more of a solution-polymerized styrene butadiene rubber and less than 50 parts by mass of a diene-based rubber other than styrene butadiene rubbers; 60 parts by mass or more of silica; and a trialkyl phosphate in an amount of 1.5 to 20 mass % of the silica content.

In general, styrene butadiene rubbers are broadly classified into solution-polymerized styrene butadiene rubbers (hereinafter also referred to as “S-SBR”) and emulsion-polymerized styrene butadiene rubbers (hereinafter also referred to as “E-SBR”). S-SBR has a narrower molecular weight distribution (Mw/Mn) than E-SBR.

S-SBR can generally be obtained by anionically polymerizing raw material monomers in a hydrocarbon and is, as compared to E-SBR obtained by an emulsion polymerization method in water (suspension polymerization method), characterized in that both the molecular weight distribution and the vinyl content can be controlled.

In the invention, modified S-SBR is preferably contained as S-SBR. Modified S-SBR contains a heteroatom-containing functional group. The heteroatom-containing functional group may be introduced at the terminal of the polymer chain or into the polymer chain, but is preferably introduced at the terminal. As heteroatom-containing functional groups, amino groups, alkoxyl groups, hydroxyl groups, epoxy groups, carboxyl groups, cyano groups, halogen groups, and the like can be mentioned. The modified S-SBR can contain at least one of the illustrated functional groups. As amino groups, a primary amino group, a secondary amino group, a tertiary amino group, and the like can be mentioned. As alkoxyl groups, a methoxy group, an ethoxy group, a propoxy group, a butoxy group, and the like can be mentioned. As halogen groups, chlorine, bromine, and the like can be mentioned. The illustrated functional groups interact with various functional groups of fillers, especially carbon black, or with silanol groups (Si—OH) of silica. Here, an interaction means, for example, in the case of silica, chemical bonding or hydrogen bonding through a chemical reaction with silanol groups of silica. Incidentally, for the purpose of improving the filling properties and workability of carbon black or silica, the S-SBR used may be an oil extended product.

The solution-polymerized styrene butadiene rubber content in 100 parts by mass of the rubber component is 30 parts by mass or more, preferably 30 to 100 parts by mass, more preferably 35 to 100 parts by mass, and still more preferably 40 to 100 parts by mass.

The rubber component may also contain an emulsion-polymerized styrene butadiene rubber (E-SBR), but the content thereof is, in 100 parts by mass of the rubber component, preferably less than 60 parts by mass, more preferably less than 50 parts, and still more preferably less than 40 parts by mass.

The rubber component may be composed only of a styrene butadiene rubber, but may further have blended therein any of diene-based rubbers other than styrene butadiene rubbers, such as natural rubbers (NR), isoprene rubbers (IR), nitrile rubbers (NBR), chloroprene rubbers (CR), butyl rubbers (IIR), styrene-isoprene copolymer rubbers, butadiene-isoprene copolymer rubbers, and styrene-isoprene-butadiene copolymer rubbers, within a range where the original effect is not impaired. The content thereof is, in 100 parts by mass of the rubber component, less than 50 parts by mass, preferably less than 40 parts by mass, and more preferably less than 30 parts by mass.

The rubber composition according to this embodiment contains silica as a reinforcing filler. Silica is not particularly limited, and, for example, wet silica such as wet-precipitated silica or wet-gelled silica may be used.

The silica content is, per 100 parts by mass of the rubber component, 60 parts by mass or more, preferably 60 to 140 parts by mass, more preferably 60 to 130 parts by mass, and still more preferably 65 to 120 parts by mass. When the silica content is within the above range, excellent rolling resistance and abrasion resistance are likely to be obtained.

As the reinforcing filler, in addition to silica, carbon black may also be used. The reinforcing filler content (the total amount of silica and carbon black) is, per 100 parts by mass of the rubber component, preferably 60 to 150 parts by mass, more preferably 60 to 140 parts by mass, and still more preferably 60 to 130 parts by mass. The carbon black content is, per 100 parts by mass of the rubber component, preferably 0.1 to 40 parts by mass, more preferably 1 to 30 parts by mass, and still more preferably 1 to 20 parts by mass.

The rubber composition according to this embodiment preferably contains a silane coupling agent. In that case, the silane coupling agent content is, per 100 parts by mass of silica, preferably 1 to 20 parts by mass, and more preferably 1 to 15 parts by mass.

The rubber composition according to this embodiment contains a trialkyl phosphate, and the content thereof is 1.5 to 20 mass % of the silica content. That is, a trialkyl phosphate is contained at a ratio of 1.5 to 20 parts by mass relative to 100 parts by mass of silica.

The trialkyl phosphate preferably has 3 to 30 carbon atoms, and more preferably 3 to 24 carbon atoms. Specifically, trimethyl phosphate, triethyl phosphate, tributyl phosphate, tri(2-ethylhexyl) phosphate, tricresyl phosphate, trixylenyl phosphate, tris(isopropylphenyl) phosphate, trinaphthyl phosphate, and the like can be mentioned.

The freezing point of the trialkyl phosphate is preferably −50° C. or less, and more preferably −55 to −90° C.

The rubber composition according to this embodiment may contain a hydrocarbon-based resin. The hydrocarbon-based resin content may be, per 100 parts by mass of the rubber component, 1 to 20 parts by mass, or 5 to 15 parts by mass. When the hydrocarbon-based resin content is within the above range, excellent rolling resistance and abrasion resistance are likely to be obtained.

As hydrocarbon-based resins, styrene-based resins, terpene-based resins, petroleum-based hydrocarbon resins, rosin-based resins, and the like can be mentioned. Among them, petroleum-based hydrocarbon resins and terpene-based resins are preferable.

Styrene-based resins may be resins containing styrene and/or α-methylstyrene as a constituent monomer, and examples thereof include homopolymers obtained by polymerizing styrene or α-methylstyrene alone, copolymers obtained by copolymerizing styrene and α-methylstyrene, and copolymers of styrene and/or α-methylstyrene with other monomers. As other monomers, for example, terpene compounds such as α-pinene, β-pinene, dipentene, limonene, myrcene, alloocimene, ocimene, α-phellandrene, α-terpinene, γ-terpinene, terpinolene, 1,8-cineole, 1,4-cineol, α-terpineol, β-terpineol, and γ-terpineol (terpene-based monomers), non-conjugated olefins such as ethylene, propylene, 1-butene, 1-pentene, 1-hexene, 1-heptene, and 1-octene, and the like can be mentioned. They may be used alone, and combined use of two or more kinds is also possible.

As terpene-based resins, for example, terpene-based resins such as an α-pinene polymer, a β-pinene polymer, and a dipentene polymer, modified terpene-based resins obtained by modifying (phenol modification, aromatic modification, hydrocarbon modification, etc.) these terpene-based resins (e.g., terpene phenol-based resins, styrene-modified terpene-based resins, aromatic-modified terpene-based resins, etc.), and the like can be mentioned.

As petroleum-based hydrocarbon resins, for example, C5-based aliphatic hydrocarbon resins, C9-based aromatic hydrocarbon resins, and C5/C9-based aliphatic/aromatic copolymer hydrocarbon resins can be mentioned. An aliphatic hydrocarbon resin is a resin obtained by the cationic polymerization of an unsaturated monomer such as isoprene or cyclopentadiene, which is a petroleum fraction equivalent to four to five carbon atoms (C5 fraction), and may also be partially hydrogenated. An aromatic hydrocarbon resin is a resin obtained by the cationic polymerization of a monomer such as vinyltoluene, an alkylstyrene, or indene, which is a petroleum fraction equivalent to eight to ten carbon atoms (C9 fraction), and may also be partially hydrogenated. An aliphatic/aromatic copolymer hydrocarbon resin is a resin obtained by copolymerizing the above C5 and C9 fractions by cationic polymerization, and may also be partially hydrogenated.

As rosin-based resins, for example, raw material rosins such as gum rosin, wood rosin, and tall oil rosin, disproportionated products of raw material rosins, polymerized rosins, and like rosins, esterified products of rosins (rosin ester resins), phenol-modified rosins, unsaturated acid- (maleic acid-, etc.) modified rosins, formylated rosins obtained by reduction-treating rosins, and the like can be mentioned.

In addition to the above components, the rubber composition according to this embodiment can have blended therein various additives generally used in rubber compositions, such as zinc oxide, stearic acid, antioxidants, waxes, oils, vulcanizing agents, and vulcanization accelerators.

A preferred example of the vulcanizing agents is sulfur. The vulcanizing agent content is not particularly limited, but is, per 100 parts by mass of the rubber component, preferably 0.1 to 10 parts by mass, and more preferably 0.5 to 5 parts by mass. In addition, as the vulcanization accelerators, for example, sulfenamide-based, thiuram-based, thiazole-based, guanidine-based, and like various vulcanization accelerators can be mentioned. They can be used alone or as a combination of two or more kinds. The vulcanization accelerator content is not particularly limited, but is, per 100 parts by mass of the rubber component, preferably 0.1 to 7 parts by mass, and more preferably 0.5 to 5 parts by mass.

The rubber composition according to this embodiment can be made by kneading in the usual manner using a commonly used mixer, such as a Banbury mixer, a kneader, or a roll. That is, for example, in the first mixing stage, additives excluding a vulcanizing agent and a vulcanization accelerator are added to the rubber component and mixed, and then, in the final mixing stage, a vulcanizing agent and a vulcanization accelerator are added to the obtained mixture and mixed, whereby a rubber composition can be prepared.

The rubber composition thus obtained is applicable to the treads of pneumatic tires of various sizes for various uses, including tires for passenger cars, large-sized tires for trucks and buses, and the like. That is, the rubber composition is formed into a predetermined shape in the usual manner, for example, by extrusion, and combined with other parts to make a green tire. Subsequently, the green tire is vulcanization-molded at 140 to 180° C., for example, whereby a pneumatic tire can be produced.

### EXAMPLES

Hereinafter, examples of the invention will be shown, but the invention is not limited to these examples.

Using a lab mixer, following the formulations (parts by mass) shown in Tables 1 to 4 below, first, in the first mixing stage, ingredients excluding sulfur and a vulcanization accelerator were added to a rubber component and kneaded (discharge temperature=160° C.). Next, in the final mixing stage, sulfur and a vulcanization accelerator were added to the obtained kneaded product and kneaded (discharge temperature=90° C.), thereby preparing a rubber composition. The details of the components in Tables 1 to 4 are as follows.
SBR 1: “HPR 350” manufactured by JSR Corporation, modified S-SBR (styrene content=20.5 mass %, microstructure of the butadiene moiety: vinyl content=55.5%)
SBR 2: “SBR 1502” manufactured by JSR Corporation, E-SBR (styrene content=23.5%)
SBR 3: “TUFDENE 1834” manufactured by Asahi Kasei Corporation, unmodified S-SBR (Tg=−68° C., 37.5 parts by mass oil extension)
SBR 4: “HPR 840” manufactured by JSR Corporation, modified S-SBR (styrene content=10 mass %, microstructure of the butadiene moiety: vinyl content=42%)
BR: “BR 150B” manufactured by Ube Industries, Ltd., vinyl content: 1%
NR: RSS#3
Carbon black: “SEAST 3” manufactured by Tokai Carbon Co., Ltd.
Silica: “Ultrasil VN3” manufactured by Evonik
Silane coupling agent: “Si-69” manufactured by Evonik, bis(3-triethoxysilylpropyl)tetrasulfide
Oil: “PROCESS NC-140” manufactured by ENEOS Corporation
Zinc oxide: “Type 2 Zinc Oxide” manufactured by Mitsui Mining & Smelting Co., Ltd.
Stearic acid: “LUNAC S-20” manufactured by Kao Corporation
Antioxidant: “Antigen 6C” manufactured by Sumitomo Chemical Co., Ltd.
Phosphate ester 1: “Tris(2-ethylhexyl) phosphate (TOP)” manufactured by Daihachi Chemical Industry Co., Ltd., freezing point: −70° C. or less
Phosphate ester 2: “Triethyl phosphate (TEP)” manufactured by Daihachi Chemical Industry Co., Ltd., freezing point: −56° C.
Ester plasticizer: “Bis(2-ethylhexyl) phthalate (DOP)” manufactured by Daihachi Chemical Industry Co., Ltd., freezing point: −50° C.
Hydrocarbon-based resin 1: C5/C9-based resin, “Petrotac 90” manufactured by Tosoh Corporation, softening point=95° C.
Hydrocarbon-based resin 2: β-pinene-based resin, “DERCOLYTE S 115” manufactured by DRT, softening point=114° C.
Sulfur: “Powder Sulfur” manufactured by Tsurumi Chemical Industry Co., Ltd.
Vulcanization accelerator 1: “SOXINOL CZ” manufactured by Sumitomo Chemical Co., Ltd.
Vulcanization accelerator 2: “NOCCELER D” manufactured by Ouchi Shinko Chemical Industrial Co., Ltd.

Each obtained rubber composition was vulcanized at 160° C. for 20 minutes to make a test piece having a predetermined shape, and measured for rolling resistance performance and abrasion resistance. The measurement methods are as follows.
Rolling Resistance Performance: Using a viscoelasticity tester manufactured by Toyo Seiki Co., Ltd., the loss coefficient tan δ was measured under the following conditions: frequency: 10 Hz, static strain: 10%, dynamic strain: 1%, temperature: 60° C., and expressed as an index taking the reciprocal of the value of the reference comparative example as 100. The larger the index, the smaller the tan δ, indicating better rolling resistance performance.
Abrasion Resistance: In accordance with JIS K6264, using a Lambourn abrasion tester manufactured by Iwamoto Seisakusho Co., Ltd., the abrasion loss was measured under the following conditions: load: 40 N, slip ratio: 30%, and expressed as an index taking the reciprocal of the value of the reference comparative example as 100. The larger the index, the smaller the abrasion loss, and the better the abrasion resistance.

Incidentally, in Table 1, Examples 1-1 to 1-5 and Comparative Example 1-2 are based on Comparative Example 1-1, Examples 1-6 to 1-8 are based on Comparative Example 1-3, and Example 1-9, Example 1-10, and Comparative Example 1-5 are based on Comparative Example 1-4. In Table 2, Examples 2-1 to 2-5, Comparative Example 2-2, and Comparative Example 2-3 are based on Comparative Example 2-1, and Examples 2-6 to 2-8 are based on Comparative Example 2-4. In Table 3, Examples 3-1 to 3-4 and Comparative Example 3-2 are based on Comparative Example 3-1, and Examples 3-5 to 3-9 and Comparative Example 3-4 are based on Comparative Example 3-3. In Table 4, Examples 4-1 to 4-4, Comparative Example 4-2, and Comparative Example 4-3 are based on Comparative Example 4-1, and Examples 4-5 to 4-9 and Comparative Example 4-5 are based on Comparative Example 4-4.

TABLE 1

| | Comp. | Comp. | Ex. | Ex. | Ex. | Ex. | Ex. | Comp. | Ex. | Ex. | Ex. | Comp. | Comp. | Ex. | Ex. |
|---|---|---|---|---|---|---|---|---|---|---|---|---|---|---|---|
| | Ex. 1-1 | Ex. 1-2 | 1-1 | 1-2 | 1-3 | 1-4 | 1-5 | Ex. 1-3 | 1-6 | 1-7 | 1-8 | Ex. 1-4 | Ex. 1-5 | 1-9 | 1-10 |
| SBR 1 | 60 | 60 | 60 | 60 | 60 | 60 | 60 | 60 | 60 | 60 | 60 | 60 | 60 | 60 | 60 |
| SBR 2 | 40 | 40 | 40 | 40 | 40 | 40 | 40 | 40 | 40 | 40 | 40 | 40 | 40 | 40 | 40 |
| Carbon black | 10 | 10 | 10 | 10 | 10 | 10 | 10 | 5 | 5 | 5 | 5 | 5 | 5 | 5 | 5 |
| Silica | 65 | 65 | 65 | 65 | 65 | 65 | 65 | 120 | 120 | 120 | 120 | 120 | 120 | 120 | 120 |
| Silane | 6.5 | 6.5 | 6.5 | 6.5 | 6.5 | 6.5 | 6.5 | 12 | 12 | 12 | 12 | 12 | 12 | 12 | 12 |
| coupling | | | | | | | | | | | | | | | |
| agent | | | | | | | | | | | | | | | |
| Oil | 20 | 0.5 | 19 | 16.75 | 13.5 | 13.5 | 10 | 45 | 39 | 33 | 21 | 30 | 30 | 21.6 | 21.6 |
| Zinc oxide | 2 | 2 | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 | 2 | 2 |
| Antioxidant | 2 | 2 | 2 | 2 | 2 | 2 | 2 | 2 | 2 | 2 | 2 | 2 | 2 | 2 | 2 |
| Phosphate | — | 19.5 | 1 | 3.25 | 6.5 | — | 10 | — | 6 | 12 | 24 | — | — | 8.4 | 8.4 |
| ester 1 | | | | | | | | | | | | | | | |
| Phosphate | — | — | — | — | — | 6.5 | — | — | — | — | — | — | — | — | — |
| ester 2 | | | | | | | | | | | | | | | |
| Hydrocarbon | — | — | — | — | — | — | — | — | — | — | — | 15 | — | 15 | — |
| resin 1 | | | | | | | | | | | | | | | |
| Hydrocarbon | — | — | — | — | — | — | — | — | — | — | — | — | 15 | — | 15 |
| resin 2 | | | | | | | | | | | | | | | |
| Sulfur | 2 | 2 | 2 | 2 | 2 | 2 | 2 | 2 | 2 | 2 | 2 | 2 | 2 | 2 | 2 |
| Vulcanization | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| accelerator | | | | | | | | | | | | | | | |
| 1 | | | | | | | | | | | | | | | |
| Vulcanization | 0.5 | 0.5 | 0.5 | 0.5 | 0.5 | 0.5 | 0.5 | 1 | 1 | 1 | 1 | 1 | 1 | 1 | 1 |
| accelerator | | | | | | | | | | | | | | | |
| 2 | | | | | | | | | | | | | | | |
| Phosphate | — | 30 | 1.5 | 5 | 10 | 10 | 15.4 | — | 5 | 10 | 20 | — | — | 7 | 7 |
| ester content | | | | | | | | | | | | | | | |
| relative to | | | | | | | | | | | | | | | |
| silica content | | | | | | | | | | | | | | | |
| (mass %) | | | | | | | | | | | | | | | |
| Rolling | 100 | 112 | 102 | 103 | 105 | 103 | 108 | 100 | 105 | 107 | 106 | 100 | 101 | 108 | 110 |
| resistance | | | | | | | | | | | | | | | |
| performance | | | | | | | | | | | | | | | |
| Abrasion | 100 | 95 | 104 | 110 | 107 | 106 | 104 | 100 | 108 | 107 | 112 | 100 | 105 | 106 | 115 |
| resistance | | | | | | | | | | | | | | | |

Ex.: Example,
Comp. Ex.: Comparative Example

TABLE 2

| | Comp. | Comp. | Comp. | Ex. | Ex. | Ex. | Ex. | Ex. | Comp. | Ex. | Ex. | Ex. |
|---|---|---|---|---|---|---|---|---|---|---|---|---|
| | Ex. 2-1 | Ex. 2-2 | Ex. 2-3 | 2-1 | 2-2 | 2-3 | 2-4 | 2-5 | Ex. 2-4 | 2-6 | 2-7 | 2-8 |
| SBR 2 | 30 | 30 | 30 | 30 | 30 | 30 | 30 | 30 | 30 | 30 | 30 | 30 |
| SBR 3 | 68.75 | — | 68.75 | 68.75 | 68.75 | 68.75 | 68.75 | — | 68.75 | 68.75 | 68.75 | 68.75 |
| | (18.75 | | (18.75 | (18.75 | (18.75 | (18.75 | (18.75 | | (18.75 | (18.75 | (18.75 | (18.75 |
| | oil) | | oil) | oil) | oil) | oil) | oil) | | oil) | oil) | oil) | oil) |
| SBR 4 | — | 50 | — | — | — | — | — | 50 | — | — | — | — |
| BR | 20 | 20 | 20 | 20 | 20 | 20 | 20 | 20 | 20 | 20 | 20 | 20 |
| Carbon black | 10 | 10 | 10 | 10 | 10 | 10 | 10 | 10 | 10 | 10 | 10 | 10 |
| Silica | 90 | 90 | 90 | 90 | 90 | 90 | 90 | 90 | 90 | 90 | 90 | 90 |
| Silane | 9 | 9 | 9 | 9 | 9 | 9 | 9 | 9 | 9 | 9 | 9 | 9 |
| coupling | | | | | | | | | | | | |
| agent | | | | | | | | | | | | |
| Oil | 20 | 38.75 | | 15.5 | 11 | 11 | 6.5 | 11 | 20 | 15.5 | 11 | 6.5 |
| Zinc oxide | 2 | 2 | 2 | 2 | 2 | 2 | 2 | — | 2 | 2 | 2 | 2 |
| Stearic acid | 2 | 2 | 2 | 2 | 2 | 2 | 2 | — | 2 | 2 | 2 | 2 |
| Antioxidant | 2 | 2 | 2 | 2 | 2 | 2 | 2 | — | 2 | 2 | 2 | 2 |
| Phosphate ester | — | — | 20 | 4.5 | 9 | — | 13.5 | 9 | — | 4.5 | 9 | 13.5 |
| 1 | | | | | | | | | | | | |
| Phosphate | — | — | — | — | — | 9 | — | — | — | — | — | — |
| ester 2 | | | | | | | | | | | | |
| Hydrocarbon | — | — | — | — | — | — | — | — | — | — | — | — |
| resin 1 | | | | | | | | | | | | |
| Hydrocarbon | — | — | — | — | — | — | — | — | 8 | 8 | 8 | 8 |
| resin 2 | | | | | | | | | | | | |
| Sulfur | 2 | 2 | 2 | 2 | 2 | 2 | 2 | 2 | 2 | 2 | 2 | 2 |
| Vulcanization | 1.5 | 1.5 | 1.5 | 1.5 | 1.5 | 1.5 | 1.5 | 1.5 | 1.5 | 1.5 | 1.5 | 1.5 |
| accelerator | | | | | | | | | | | | |
| 1 | | | | | | | | | | | | |
| Vulcanization | 1 | 1 | 1 | 1 | 1 | 1 | 1 | 1 | 1 | 1 | 1 | 1 |
| accelerator | | | | | | | | | | | | |
| 2 | | | | | | | | | | | | |
| Phosphate | — | — | 22.2 | 5 | 10 | 10 | 15 | 10 | — | 5 | 10 | 15 |
| ester content | | | | | | | | | | | | |
| relative to | | | | | | | | | | | | |
| silica content | | | | | | | | | | | | |
| (mass %) | | | | | | | | | | | | |
| Rolling | 100 | 104 | 106 | 102 | 103 | 102 | 104 | 109 | 100 | 103 | 104 | 106 |
| resistance | | | | | | | | | | | | |
| performance | | | | | | | | | | | | |
| Abrasion | 100 | 97 | 100 | 108 | 105 | 110 | 104 | 106 | 100 | 110 | 106 | 104 |
| resistance | | | | | | | | | | | | |

Ex.: Example,
Comp. Ex.: Comparative Example

TABLE 3

| | Comp. | Comp. | Ex. | Ex. | Ex. | Ex. | Comp. | Comp. | Ex. | Ex. | Ex. | Ex. | Ex. |
|---|---|---|---|---|---|---|---|---|---|---|---|---|---|
| | Ex. 3-1 | Ex. 3-2 | 3-1 | 3-2 | 3-3 | 3-4 | Ex. 3-3 | Ex. 3-4 | 3-5 | 3-6 | 3-7 | 3-8 | 3-9 |
| SBR 1 | 40 | 40 | 40 | 40 | 40 | 40 | 40 | 40 | 40 | 40 | 40 | 40 | 40 |
| SBR 2 | 40 | 40 | 40 | 40 | 40 | 40 | 40 | 40 | 40 | 40 | 40 | 40 | 40 |
| NR | 20 | 20 | 20 | 20 | 20 | 20 | 20 | 20 | 20 | 20 | 20 | 20 | 20 |
| Carbon black | 5 | 5 | 5 | 5 | 5 | 5 | 5 | 5 | 5 | 5 | 5 | 5 | 5 |
| Silica | 100 | 100 | 100 | 100 | 100 | 100 | 100 | 100 | 100 | 100 | 100 | 100 | 100 |
| Silane coupling agent | 10 | 10 | 10 | 10 | 10 | 10 | 10 | 10 | 10 | 10 | 10 | 10 | 10 |
| Oil | 25 | — | 20 | 15 | 15 | 5 | 25 | 25 | 20 | 15 | 20 | 15 | 10 |
| Zinc oxide | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 |
| Antioxidant | 2 | 2 | 2 | 2 | 2 | 2 | 2 | 2 | 2 | 2 | 2 | 2 | 2 |
| Phosphate ester 1 | — | 25 | 5 | 10 | — | 20 | — | — | 5 | 10 | 5 | 10 | 15 |
| Phosphate ester 2 | — | — | — | — | 10 | — | — | — | — | — | — | — | — |
| Hydrocarbon resin 1 | — | — | — | — | — | — | 10 | — | 10 | 10 | — | — | — |
| Hydrocarbon resin 2 | — | — | — | — | — | — | — | 10 | — | — | 10 | 10 | 10 |
| Sulfur | 2 | 2 | 2 | 2 | 2 | 2 | 2 | 2 | 2 | 2 | 2 | 2 | 2 |
| Vulcanization accelerator | 1.5 | 1.5 | 1.5 | 1.5 | 1.5 | 1.5 | 1.5 | 1.5 | 1.5 | 1.5 | 1.5 | 1.5 | 1.5 |
| 1 | | | | | | | | | | | | | |
| Vulcanization accelerator | 1 | 1 | 1 | 1 | 1 | 1 | 1 | 1 | 1 | 1 | 1 | 1 | 1 |
| 2 | | | | | | | | | | | | | |
| Phosphate ester content | — | 25 | 5 | 10 | 10 | 20 | — | — | 5 | 10 | 5 | 10 | 15 |
| relative to silica content | | | | | | | | | | | | | |
| (mass %) | | | | | | | | | | | | | |
| Rolling resistance | 100 | 110 | 103 | 105 | 104 | 108 | 100 | 98 | 103 | 105 | 102 | 104 | 107 |
| performance | | | | | | | | | | | | | |
| Abrasion resistance | 100 | 100 | 107 | 108 | 106 | 105 | 100 | 108 | 106 | 110 | 114 | 118 | 115 |

Ex.: Example,
Comp. Ex.: Comparative Example

TABLE 4

| | Comp. | Comp. | Comp. | Ex. | Ex. | Ex. | Ex. | Comp. | Comp. | Ex. | Ex. | Ex. | Ex. | Ex. |
|---|---|---|---|---|---|---|---|---|---|---|---|---|---|---|
| | Ex. 4-1 | Ex. 4-2 | Ex. 4-3 | 4-1 | 4-2 | 4-3 | 4-4 | Ex. 4-4 | Ex. 4-5 | 4-5 | 4-6 | 4-7 | 4-8 | 4-9 |
| SBR 1 | 60 | 60 | 60 | 60 | 60 | 60 | 60 | 60 | 60 | 60 | 60 | 60 | 60 | 60 |
| BR | 20 | 20 | 20 | 20 | 20 | 20 | 20 | 20 | 20 | 20 | 20 | 20 | 20 | 20 |
| NR | 20 | 20 | 20 | 20 | 20 | 20 | 20 | 20 | 20 | 20 | 20 | 20 | 20 | 20 |
| Carbon black | 5 | 5 | 5 | 5 | 5 | 5 | 5 | 5 | 5 | 5 | 5 | 5 | 5 | 5 |
| Silica | 100 | 100 | 100 | 100 | 100 | 100 | 100 | 100 | 100 | 100 | 100 | 100 | 100 | 100 |
| Silane coupling agent | 10 | 10 | 10 | 10 | 10 | 10 | 10 | 10 | 10 | 10 | 10 | 10 | 10 | 10 |
| Oil | 25 | — | 20 | 20 | 15 | 15 | 5 | 25 | 25 | 20 | 15 | 20 | 15 | 10 |
| Zinc oxide | 2 | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 | 2 |
| Antioxidant | 2 | 2 | 2 | 2 | 2 | 2 | 2 | 2 | 2 | 2 | 2 | 2 | 2 | 2 |
| Phosphate ester 1 | — | 25 | — | 5 | 10 | — | 20 | — | — | 5 | 10 | 5 | 10 | 15 |
| Phosphate ester 2 | — | — | — | — | — | 10 | — | — | — | — | — | — | — | — |
| Ester plasticizer | — | — | 5 | — | — | — | — | — | — | — | — | — | — | — |
| Hydrocarbon resin 1 | — | — | — | — | — | — | — | 10 | — | 10 | 10 | — | — | — |
| Hydrocarbon resin 2 | — | — | — | — | — | — | — | — | 10 | — | — | 10 | 10 | 10 |
| Sulfur | 2 | 2 | 2 | 2 | 2 | 2 | 2 | 2 | 2 | 2 | 2 | 2 | 2 | 2 |
| Vulcanization accelerator | 1.5 | 1.5 | 1.5 | 1.5 | 1.5 | 1.5 | 1.5 | 1.5 | 1.5 | 1.5 | 1.5 | 1.5 | 1.5 | 1.5 |
| 1 | | | | | | | | | | | | | | |
| Vulcanization accelerator | 1 | 1 | 1 | 1 | 1 | 1 | 1 | 1 | 1 | 1 | 1 | 1 | 1 | 1 |
| 2 | | | | | | | | | | | | | | |
| Phosphate ester content | — | 25 | — | 5 | 10 | 10 | 20 | — | — | 5 | 10 | 5 | 10 | 15 |
| relative to silica content | | | | | | | | | | | | | | |
| (mass %) | | | | | | | | | | | | | | |
| Rolling resistance | 100 | 114 | 103 | 105 | 107 | 106 | 110 | 100 | 100 | 104 | 108 | 105 | 108 | 109 |
| performance | | | | | | | | | | | | | | |
| Abrasion resistance | 100 | 100 | 98 | 114 | 115 | 110 | 106 | 100 | 110 | 110 | 109 | 120 | 120 | 117 |

Ex.: Example,
Comp. Ex.: Comparative Example

The results are as shown in Tables 1 to 4. Compared to Comparative Example 1-1, Examples 1-1 to 1-5 were superior in rolling resistance performance and abrasion resistance. Meanwhile, Comparative Example 1-2 is an example in which the phosphate ester content exceeded the upper limit, and was inferior to Comparative Example 1-1 in abrasion resistance.

Examples 1-6 to 1-8 were superior to Comparative Example 1-3 in rolling resistance performance and abrasion resistance.

Example 1-9 was superior to Comparative Example 1-4 in rolling resistance performance and abrasion resistance. Example 1-10 was superior to Comparative Example 1-5 in rolling resistance performance and abrasion resistance.

Examples 2-1 to 2-4 were superior to Comparative Example 2-1 in rolling resistance performance and abrasion resistance. Comparative Example 2-2 is an example in which modified S-SBR was used. Although rolling resistance performance improved over Comparative Example 2-1, abrasion resistance deteriorated. Meanwhile, Example 2-5 is an example in which modified S-SBR and a phosphate ester were used together, and was superior to Comparative Example 2-1 in rolling resistance performance and abrasion resistance.

Examples 2-6 to 2-8 were superior to Comparative Example 2-4 in rolling resistance performance and abrasion resistance.

Compared to Comparative Example 3-1, Examples 3-1 to 3-4 were superior in rolling resistance performance and abrasion resistance. Meanwhile, Comparative Example 3-2 is an example in which the phosphate ester content exceeded the upper limit, and no improvement in abrasion resistance over Comparative Example 3-1 was observed.

Example 3-5 and Example 3-6 were superior to Comparative Example 3-3 in rolling resistance performance and abrasion resistance. Examples 3-7 to 3-9 were superior to Comparative Example 3-4 in rolling resistance performance and abrasion resistance.

Compared to Comparative Example 4-1, Examples 4-1 to 4-4 were superior in rolling resistance performance and abrasion resistance. Meanwhile, Comparative Example 4-2 is an example in which the phosphate ester content exceeded the upper limit, and no improvement in abrasion resistance over Comparative Example 4-1 was observed. In addition, Comparative Example 4-3 is an example in which an ester plasticizer was used instead of a phosphate ester, and abrasion resistance deteriorated.

Example 4-5 and Examples 4-6 were superior to Comparative Example 4-4 in rolling resistance performance and abrasion resistance. Examples 4-7 to 4-9 were superior to Comparative Example 4-5 in rolling resistance performance and abrasion resistance.

The rubber composition of the invention can be used as a rubber composition for various tires for passenger cars, light trucks, buses, and the like.

What is claimed is:

1. A rubber composition for a tread, comprising:
100 parts by mass of a rubber component containing 30 parts by mass or more of a solution-polymerized styrene butadiene rubber and less than 50 parts by mass of a diene-based rubber other than styrene butadiene rubbers;
60 parts by mass or more of silica; and
a trialkyl phosphate in an amount of 1.5 to 20 mass % of the silica content.

2. The rubber composition for a tread according to claim 1, wherein the trialkyl phosphate has 3 to 30 carbon atoms.

3. The rubber composition for a tread according to claim 1, wherein the solution-polymerized styrene butadiene rubber includes a modified solution-polymerized styrene butadiene rubber.

4. The rubber composition for a tread according to claim 1, further comprising a hydrocarbon-based resin.

5. A tire comprising the rubber composition according to claim 1 used in a tread thereof.

6. A tire comprising the rubber composition according to claim 2 used in a tread thereof.

7. A tire comprising the rubber composition according to claim 3 used in a tread thereof.

8. A tire comprising the rubber composition according to claim 4 used in a tread thereof.
